(19) United States
(12) Patent Application Publication
(10) Pub. No.: US 2010/0181408 A1
(43) Pub. Date: Jul. 22, 2010

(54) Belt Tensioner With a Cup-Shaped Drive Piston

(76) Inventors: Stefan Suhr, Elmshorn (DE); Erne Frey, Elmshorn (DE); Martin Schmidt, Elmshorn (DE)

Correspondence Address: Brinks Hofer Gilson & Lione/Ann Arbor, 524 South Main Street, Suite 200, Ann Arbor, MI, 48104, US

(21) Appl. No.: 12/665,942

(22) PCT Filed: Jun. 11, 2008
(86) PCT No.: PCT/EP2008/004644

§ 371 Date: Mar. 25, 2010

(30) Foreign Application Priority Data
Jun. 23, 2007 (DE) 10 2007 028 980.6

(51) Int. Cl. B60R 22/46

(52) U.S. Cl. 242/374

(57) ABSTRACT

A belt pretensioner for safety belts, in particular in motor vehicles, with a pretensioner drive which, in the event it is triggered, can be coupled to the belt shaft, and includes a drive wheel which is enclosed over at least part of its volume by a tubular housing which forms a channel in its interior, whereby, in order to drive the drive wheel, a plurality of solid balls, which are accelerated by means of a pyrotechnic drive, can be guided through the channel, and a drive piston for the solid balls is arranged at that end of the channel which is to be acted upon by the gas introduced, characterized in that the drive piston (19) is designed in the manner of a hollow cup and, on its closed end side (27), is provided with an inwardly directed curvature (28) adapted to the contour of a solid ball (18).

### CROSS REFERENCE TO RELATED APPLICATION

This application claims priority to International Application No. PCT/EP2008/004644, filed Jun. 11, 2008, which is based on and claims priority to German Patent Application No. 10 2007 028 980.6, filed Jun. 23, 2007.

### FIELD OF THE INVENTION

The present invention relates to a seat belt tightener or pretentioner for safety belts, in particular in motor vehicles.

### BACKGROUND OF THE INVENTION

The pretensioner in accordance with this invention includes a pretensioner drive which, in the event it is triggered, can be coupled to the belt retractor shaft, and which includes a drive wheel which is enclosed over at least part of its volume by a tubular housing which forms a channel in its interior, whereby, in order to drive the drive wheel, a plurality of solid balls, which, accelerated by means of a pyrotechnic drive, can be guided through the channel, and a drive piston for the solid balls is arranged at that end of the channel which is to be acted upon by the introduced gas.

A pretentioner having the above mentioned characteristics has been described in DE 196 02 549 B4. In the known construction, the piston is constructed as a twin ball in which one of the solid balls forming the twin balls bears a sealing pressing against the inner wall of the tubular housing in the form of a sealing ring inserted into a groove constructed on the respective solid ball. The known piston construction is associated with the disadvantage that manufacturing the drive piston with the twin ball, cutting the groove into one of the solid balls, and mounting the sealing ring is accordingly costly. Moreover, during the movement of the drive piston through the channel, the sealing ring that is clamped between the solid ball and the wall of the tubular housing with a corresponding pre-tension for reasons of tightness correspondingly causes high frictional forces.

### BRIEF DESCRIPTION OF THE INVENTION

The present invention is therefore based upon the objective of simplifying the design of the drive piston and reducing the frictional forces originating from the forward movement of the drive piston through the tubular housing in connection with a belt pretensioner having the above mentioned representative features.

The attainment of this object, including advantageous refinements and further developments of the present invention, will become apparent from the claims following this description.

In its fundamental idea, the present invention provides that the drive piston is configured like a hollow cup, and at its closed end side is provided with an inwardly directed vaulting or depression that is adapted to the contour of a solid ball. The present invention is associated with the advantage that the drive piston forms a part to be produced in a single piece which can be manufactured in one operation without additional processing. Due to the gas pressure prevailing inside the cup-shaped drive piston, when the pretensioner drive is triggered, the rear edge of the drive piston is pressed against the wall of the tubular housing that forms the channel so that a good seal exists. A further advantage is that the cup-shaped drive piston has a preset volume for the gas volume that is formed when the pretensioner drive is triggered, as a result of which, taking into consideration the overall required gas pressure, the installation space is minimized. The depression configured in the closed end face of the drive piston provides for good guidance of the series of solid balls arranged in the channel of the tubular housing.

According to an embodiment of the present invention, it is provided that the cup-shaped drive piston has a conical shape tapering in the direction of the solid bodies. With this, the tightness of the drive piston relative to the tubular housing is improved by the tendency of the conical shape of the piston to expand induced by the gas pressure. In this connection, according to an embodiment of the present invention, it may be provided that the conical shape of the drive piston is graduated at least once along its longitudinal axis.

It may specifically be provided that at its end opposite the end face, the drive piston presses against the inner surface of the tubular housing receiving the channel with a linear sealing rim. By means of the quasi ring-shaped attachment of the rear sealing rim, the frictional forces generating from the movement of the drive piston through the tubular housing are minimized. This involves an increase in the efficiency of the pretensioner drive.

According to embodiments of the present invention, it can be provided that the piston is made of steel, and in particular configured as a deep-drawn steel part.

The drawings reproduce an embodiment of the present invention, which is described below, wherein:

### BRIEF DESCRIPTION OF THE DRAWINGS

FIG. 1 illustrates a spatial representation of a belt rewinding shaft with pretensioner drive in accordance with the present invention, and

FIG. 2 is a cross-sectional view of a detailed representation of the drive piston.

### DETAILED DESCRIPTION OF THE INVENTION

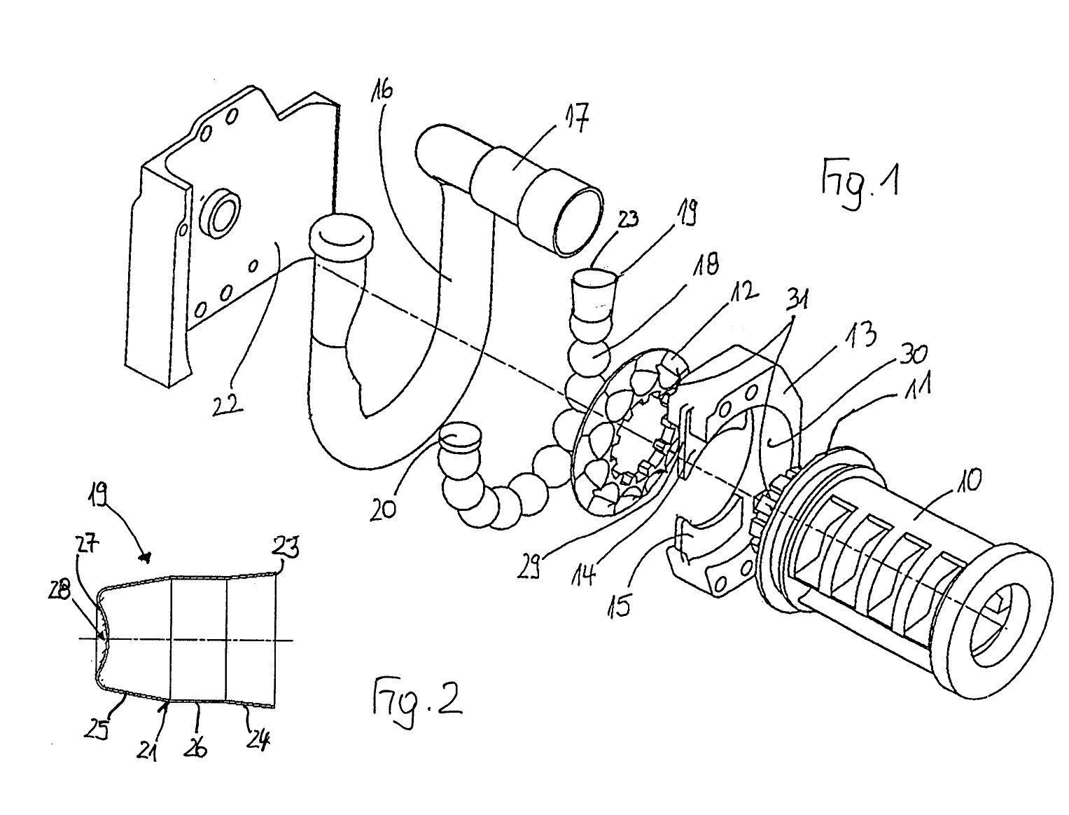

As is not further shown in detail, a belt rewinding shaft (or spool) 10 is rotatably mounted in a normally U-shaped and load-bearing belt retractor housing. In order to set the belt rewinding shaft 10 into a rotation tightening the belt wound around it, a pyrotechnic drive is provided that consists of both first and second drive wheel halves 11 and 12, whereby the first drive wheel half 11 is firmly connected to the belt rewinding shaft 10 in the embodiment represented. As is apparent from FIG. 1, on assembly of the rotary tightening device, the second drive wheel half 12 is mounted against the first drive wheel half 11 and connected thereto by means of a gear 31. A casing 13 which is part of the housing of the belt retractor is arranged between both drive wheel halves 11 and 12, which in the meantime bears the tongue-shaped channels 14, 15 reaching in-between both drive wheel halves 11 and 12 and encloses the outer volume of the drive wheel halves 11 and 12 with its inner volume 30.

A curved tubular housing 16 is arranged at the level of casing 13 and/or drive wheel halves 11 and 12 in whose interior channel the solid balls 18 for accelerating the drive wheel halves 11 and 12 are stored. A gas generator receptacle 17 is arranged at one end of the tubular housing 16 that accommodates a gas generator not shown in detail, whose gas released in the event of being triggered causes the solid balls 18 to be expelled from the tubular housing 16. For this purpose, a drive piston 19 allocated to the gas generator receptacle 17 is arranged in the tubular housing 16, while a tube plug 20 is located at the opposite end of the series of balls 18. A cover plate 22 is mounted outside on the tubular housing 16 which is connected to the allocated U-shaped leg of the belt retractor housing and also supports and holds the tubular housing 16 and the casing 13.

As is apparent in detail from FIG. 2, the drive piston 19 indicated in FIG. 1 is configured like a concave cup with an end face 27 pointing to the arrangement of the solid balls 18 in the channel of the tubular housing 16. Overall, the drive piston 19 has a stepped conical shape, in that a central cylindrical part 26 has a first step 25 that conically tapers forward toward the front end face 27, and opposed thereto a second step 24 that conically increases in diameter in the backward direction connected to it. A sealing rim 23 is configured at the rear end of the second conical step 24, which lies against the inner surface of the tubular housing 16 that accommodates the channel with a linear attachment, and provides for the sealing of the drive piston 19 relative to the tubular housing 16. The front end face 27 is provided with a vaulting or depression 28, which is adapted to the contour of a solid ball 18 such that positive guiding of the end of the chain of solid balls results during the forward movement of the drive piston 19 through the tubular housing 16.

When the gas generator is triggered, the released gas first enters the preset volume formed by the hollow drive piston 19 and, after correspondingly building up pressure, on the one hand, pushes ahead the drive piston 19 in the tubular housing 16, whereby on the other hand, the rear sealing rim 23 of the drive piston 19 is at the same time increasingly pressed against the inner surface of the tubular housing 16 that forms the channel, so that a good seal between the drive shaft 19 and the tubular housing 16 results. Owing to the quasi ring-shaped attachment of the sealing rim 23, the frictional forces arising during the forward movement of the drive piston 19 are diminished.

While the above description constitutes the preferred embodiment of the present invention, it will be appreciated that the invention is susceptible to modification, variation, and change without departing from the proper scope and fair meaning of the accompanying claims.

1. A belt pretensioner for motor vehicle safety belts of the type having a pretensioner drive which, in the event it is triggered causing a gas to be Pyrotechnically produced, and is coupled to a belt shaft to wind the shaft, comprising;
a drive wheel which is at least partially enclosed by a tubular housing which forms a channel,
a plurality of balls positioned in a string, which are accelerated by means of the pyrotechnically produced gas to be guided through the channel,
a drive piston for the balls is arranged at that end of the channel which is to be acted upon by the produced gas the drive piston in the form of a hollow cup with a closed end side, the closed end side is provided with an inwardly directed curvature adapted to the contour of a ball for pushing the string of balls upon triggering of the pretensioner.

2. The belt pretensioner according to claim 1, wherein the drive piston has a conical shape tapering in the direction of the string of balls.

3. The belt pretensioner according to claim 2, wherein the conical shape of the drive piston is graduated to form at least one step along its longitudinal axis.

4. A belt pretensioner according to claims 1 wherein at its end opposite the closed end side of the drive piston presses against the inner surface of the tubular housing with a perimeter sealing rim.

5. A belt pretensioner according to claims 1, wherein the drive piston is formed of steel.

6. A belt pretensioner according to claims, wherein the drive piston is configured as a deep-drawn steel part.

7. A belt pretensioner according to claim 1 wherein the drive piston forms a first conical step joining the closed end and increasing in diameter to join a center cylindrical section, and forming a second step joining the center section and increasing in diameter to form a sealing rim at an end of the drive piston opposite the closed ends.
